(19) United States
(12) Patent Application Publication
(10) Pub. No.: US 2005/0122417 A1
(43) Pub. Date: Jun. 9, 2005

(54) Solid-state image sensor and manufacturing method thereof

(76) Inventor: Masakatsu Suzuki, Hirakata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/983,598

(22) Filed: Nov. 9, 2004

(30) Foreign Application Priority Data
Nov. 10, 2003 (JP) 2003-380340

(51) Int. Cl. H04N 5/225

(52) U.S. Cl. 348/340

(57) ABSTRACT

A solid-state image sensor of the present invention has optical units separating incident light into a plurality of color lights, each of which separates the incident light into one of the color lights; light receptors corresponding to the color lights, each of which is formed in a semiconductor substrate and converts one of the color lights separated by the optical units; and antireflection films, each of which reduces light reflection on a surface of the light receptor.

### BACKGROUND OF THE INVENTION

(1) Field of the Invention

The present invention relates to a solid-state image sensor and a manufacturing method thereof, in particular to a solid-state image sensor which provides improved picture quality and sensitivity of an output picture and a manufacturing method thereof.

(2) Description of the Related Art

In recent years, as a solid-state image sensor, a Charge Coupled Device (CCD) is mainly used for reading a signal charge. Along with an increase in high pixel count and miniaturization of the solid-state image sensor seeking to achieve high resolution and miniaturization of an optical system, an improvement of sensibility has been a challenge.

FIG. 1 shows a cross-section diagram of a solid-state image sensor used in general for a color camera and the like. A solid-state image sensor 20 has a structure in which a transfer electrode 4 is formed, via an insulating film 3, on a silicon substrate 1 in which a light receptor (photodiode) 2 is formed for obtaining a signal charge by a photoelectric conversion. Further, an interlayer insulating film 5, a silicon oxide film 6, a shielding film 8 which has an aperture above the light receptor 2, a passivation film 9, a flat film 10, a color filter 11 and a microlens 12 are sequentially laminated. The light receptors 2 are arranged two-dimensionally so as to align alternately to CCD units. A pair of the light receptor 2 and the CCD unit constitutes one pixel. Incident light condensed by the microlens 12 is divided for each pixel, by the color filter 11, into one of three primary colors of red light (R), green light (G) and blue light (B). The separated red light is inputted into an R light receptor; the green light is inputted into a G light receptor; and the blue light is inputted into a B light receptor.

In such solid-state image sensor, because of a difference of refractive indexes between a silicon oxide film material used as the passivation film 9 and the flat film 10, and the silicon substrate 1, the light which achieves the light receptor 2 is lost due to reflection of the incident light on the surface of the silicon substrate 1, causing a deterioration of sensibility.

In order to solve the problem, it is suggested to set an antireflection film 7 made of a silicon nitride film at the top of the light receptor 2 so as to reduce the reflection of the incident light using a multiple beam interference effect and to improve the sensibility (e.g. refer to Japanese Laid-Open Patent applications No. S63-14466 and No. H4-152674).

However, in the conventional solid-state image sensor 20, in all of the R light receptors, G light receptors and B light receptors, a thickness of the antireflection film 7 is set to reduce the reflective index most for a wavelength, for example, in a wavelength range around 550 nm, so that it cannot sufficiently reduce the reflection of incident light in all wavelength ranges. Therefore, there is a problem that it is difficult to sufficiently improve the sensibility of the solid-state image sensor used for a color camera and the like.

As an example, FIG. 2 shows a result by which a reflective index in the conventional solid-state image sensor is measured. The conventional solid-state image sensor uses silicon nitride films with thickness of 50 nm as the antireflection films 7 for all of the R light receptors, the G light receptors and B light receptors. Therefore, it cannot sufficiently reduce the reflection of the incident light for light in all wavelength ranges.

Also, in the conventional solid-state semiconductor apparatus, the silicon nitride film used as the antireflection film 7 does not have good hydrogen permeability due to its compact crystal structure. Therefore, it is difficult to sufficiently improve picture quality because the supply of hydrogen necessary for reducing dark currents to the substrate is prevented. Additionally, the silicon nitride film has strong internal stress so that it is likely to cause flaws in picture quality, so called white scratches, influenced by stress density at a step and the like. Consequently, the thickness of the antireflection film 7 is restricted.

### SUMMARY OF THE INVENTION

An object of the present invention is to provide a solid-state image sensor which effectively controls reflection of incident light in all wavelength ranges entering the light receptors, and has good picture quality and high sensibility of an output picture, and a manufacturing method thereof.

In order to achieve the objective, a solid-state image sensor according to the present invention comprises: optical units operable to separate incident light into a plurality of color lights, each of said optical units separating the incident light into one of the color lights; light receptors respectively corresponding to the color lights, each of said light receptors being formed in a semiconductor substrate, and each of said light receptors converting one of the color lights separated by said optical unit into a charge; and antireflection films, each formed above respective light receptor and reducing light reflection on a surface of said light receptor, said antireflection films including at least two types of films, and a thickness of a first type of said films being different from a thickness of a second type of said films.

Accordingly, reflection of light entering each of said light receptors is effectively reduced for each color light separated by said optical unit so that, as a solid-state image sensor as a whole, reflection of light in all wavelength ranges can be effectively reduced.

For example, in the case where the incident light is separated into three primary colors of R, G and B by color filters, the thickness of the antireflection film of R light receptor is set in order to reduce photoreflectance in a wavelength range of red right so that, compared to the conventional technology, an image signal which has higher sensibility can be obtained. Similarly, a thickness of said each antireflection film is set differently for the G light receptor for a wavelength range of green right and the B light receptor for a wavelength range of blue light so as to reduce photoreflectance of each color of light. Thus, compared to the conventional technology, the solid-state image sensor of the present invention can obtain an image signal in high sensibility.

Further, first antireflection films for a first-color light (e.g. blue) and second antireflection films for a second-color light (e.g. green and red), said first antireflection films being thinner than said second antireflection films, and the second-color light having a longer wavelength than the first-color light. Further, a thickness of each of said antireflection films is set so as to have a minimum reflectance in a wavelength range of one of the color lights respectively entering said light receptors.

According to the structure, the reflection of incident light can be effectively controlled further.

Also, in the solid-state image sensor according to the present invention, it is preferred that a silicon oxide film is formed between the semiconductor substrate and the antireflection film in terms of picture quality such as so-called white scratch flaws and dark currents.

In accordance with the preferred example, crystal defects generated in the silicon substrate influenced by an etching and the like that are performed in the latter processes can be reduced so that flaws of picture quality such as white scratches are unlikely to be generated.

Further, the solid-state image sensor according to the present invention comprises: optical units operable to separate incident light into a plurality of color lights, each of said optical units separating the incident light into one of the color lights; light receptors respectively corresponding to the color lights, each of said light receptors being formed in a semiconductor substrate, and each of said light receptors converting one of the color lights separated by said optical units into a charge; silicon oxide films, each formed above respective light receptor, said silicon oxide films including at least two types of films, and a thickness of a first type of said films being different from a thickness of a second type of said films; and antireflection films, each formed above respective silicon oxide film, and reducing reflection on a surface of said light receptor.

Accordingly, because of the reason that the flaws in picture quality such as white scratches are generated by the internal pressure of the antireflection film, even in the case where the thickness of the antireflection film is restricted, the reflection of light entering each light receptor can be effectively reduced for each color light separated by said optical unit so that, as the solid-state image sensor as a whole, the reflection of incident light in all wavelength ranges can be reduced.

For example, in the case where the incident light is separated into three primary colors of R, G and B by color filters, an image signal which has higher sensibility compared to the conventional technology can be obtained in the structure where the thickness of said silicon oxide film is set so as to reduce the reflectance of each color: the R light receptor for a wavelength of red light; and the G light receptor for a wavelength of green light.

Further, said silicon oxide films includes first silicon oxide films for a first-color light and second silicon oxide films for a second-color light, said first silicon oxide films being thinner than said second silicon oxide films, and the second-color light having a longer wavelength than the first-color light.

According to the structure, the reflection of incident light can be effectively controlled further.

Furthermore, a thickness of each of said silicon oxide films is from 5 nm to 25 nm inclusive.

In terms of picture quality such as so-called white scratch flaws and dark current, it is preferred that the thickness of said silicon oxide film between the semiconductor substrate and said antireflection film is 5 nm or more. According to the preferred example, the crystal defects to be generated in said silicon substrate influenced by the etching and the like that are performed in the latter processes can be reduced so that the flaws of picture quality such as white scratches are unlikely to be generated. If said silicon oxide film is 5 nm or thinner, the picture quality is deteriorated due to the increase of local leak currents due to the dispersion of film thicknesses and interface state.

On the other hand, in terms of antireflection, said silicon oxide film is preferred to be thinner, that is, the thickness of said silicon oxide film is preferred to be 25 nm or thinner. If said silicon oxide film is thicker, an effective refractive index of said silicon oxide film and said antireflection film becomes smaller and the antireflection effect is reduced. If said silicon oxide film is 25 nm or thicker, the antireflection effect is hardly effective in a light receptor which receives light of short wavelength, for example, blue light.

Also, in the solid-state image sensor according to the present invention, each of said antireflection films includes at least one compound selected from the group consisting of titanium oxide, niobium oxide, tantalum oxide, zirconium oxide, indium oxide, cerium oxide, hafnium oxide, molybdenum oxide, tin oxide, zinc oxide and zinc sulfide.

Consequently, the constituent of said antireflection film has a smaller internal stress compared to the nitride silicon used conventionally so that the stress intensity in a step generated in a film and the like is small and the flaws in picture quality such as white scratches can be reduced. Also, due to good hydrogen permeability, the hydrogen necessary for reducing dark currents is sufficiently supplied to the substrate.

Further, in the case where a silicon nitride film is used as an antireflection film, the shape is restricted for securing hydrogen permeability. However, in this invention, such restriction is unnecessary. Therefore, the shape of the antireflection film can be variously set so that further high sensibility and a simplification of the manufacturing process can be achieved depending on the design ideas. Also, the constituent of the antireflection film has larger refractive index compared to the nitride silicon which is conventionally used so that the reflection of incident light on a surface of the silicon substrate can be more effectively controlled and the sensibility is improved.

Further, a manufacturing method of a solid-state image sensor of the present invention comprises: forming light receptors in a semiconductor substrate, each of the light receptors performing photoelectric conversion; forming antireflection films above the respective light receiving receptors, each of the antireflection films having a thickness selected out of at least two types of thicknesses; and forming optical units separating incident light into a plurality of color lights above the respective antireflection films, each of the optical units leading one of the separated color light into the respective light receptor.

Here, said forming of the antireflection films includes at least one of reducing the thickness of the antireflection film by an etching method, and of increasing the thickness of the antireflection film by a Chemical-Vapor Deposition method or a spattering method.

Furthermore, in the manufacturing method of the solid-state image sensor, wherein in said forming of the silicon oxide films, a thickness of each of the silicon oxide films is set so as to have a minimum reflectance in a wavelength range of one of the color light of the incident light.

As described in the above, according to the present invention, by setting the thickness of said antireflection film to have a value which differs for each color of light entering said each light receptor, the reflection of the received light in a specific wavelength can be effectively reduced. Therefore, as a solid-state image sensor as a whole, the reflection of incident right in all wavelength ranges can be effectively reduced. As the result, the sensibility of the solid-state image sensor used for a color camera and the like can be improved.

Also, by setting the thicknesses of said silicon oxide films formed above said light receptors are set to different values respectively depending on colors of light entering each of said light receptors, the flaws in picture quality such as white scratches are likely to be generated because of the internal pressure of said antireflection films, even in the case where the thicknesses of said antireflection films are restricted, the reflection of light around a specific wavelength can be effectively reduced so that the reflection of incident light in all wavelength ranges can be effectively reduced.

Further, in the solid-state image sensor, the antireflection film includes at least one of material selected from the group consisting of titanium oxide, niobium oxide, tantalum oxide, zirconium oxide, indium oxide, cerium oxide, hafnium oxide, molybdenum oxide, tin oxide, zinc oxide and zinc sulfide. Therefore, the internal pressure becomes smaller compared to the nitride silicon which is used conventionally and the stress intensity in a step generated in a film becomes smaller so that flaws in picture quality such as white scratches can be reduced. Furthermore, because of the good hydrogen permeability, necessary hydrogen for reducing dark currents can be efficiently supplied to the substrate. As further information about technical background to this application, the disclosure of Japanese Patent Application No. 2003-380340 filed on Nov. 10, 2003 is incorporated herein by reference.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 is a cross-section diagram showing a structure of a conventional solid-state image sensor.

FIG. 2 is a diagram showing a measurement result of photoreflectance of the conventional solid-state image sensor.

FIG. 3 is a cross-section diagram showing a structure of a solid-state image sensor according to the first embodiment of the present invention.

FIG. 4 is a diagram showing a measurement result of photoreflectance of the solid-state image sensor according to the first embodiment of the present invention.

FIG. 5 is a diagram showing a relationship between a thickness of a silicon oxide film under an antireflection film and the photoreflectance.

FIG. 6 is a cross-section diagram showing a structure of a solid-state image sensor according to the second embodiment of the present invention.

FIG. 7 is a diagram showing a measurement result of photoreflectance of the solid-state image sensor according to the second embodiment of the present invention.

FIG. 8 is a diagram showing a measurement result of photoreflectance of a solid-state image sensor according to third embodiment of the present invention.

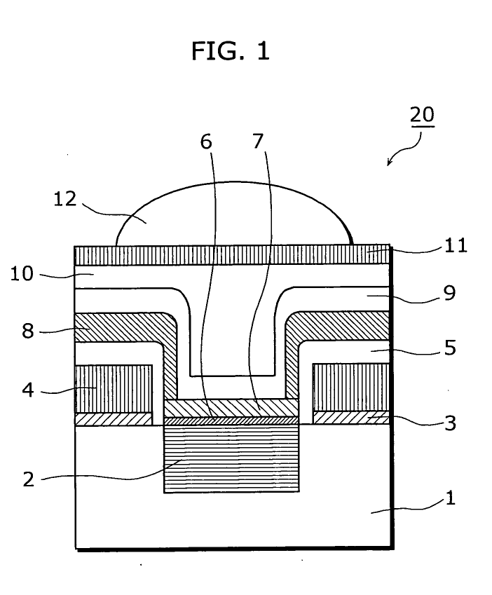

### DESCRIPTION OF THE PREFERRED EMBODIMENT(S)

Hereafter, embodiments of the present invention are specifically explained with references to drawings.

### First Embodiment

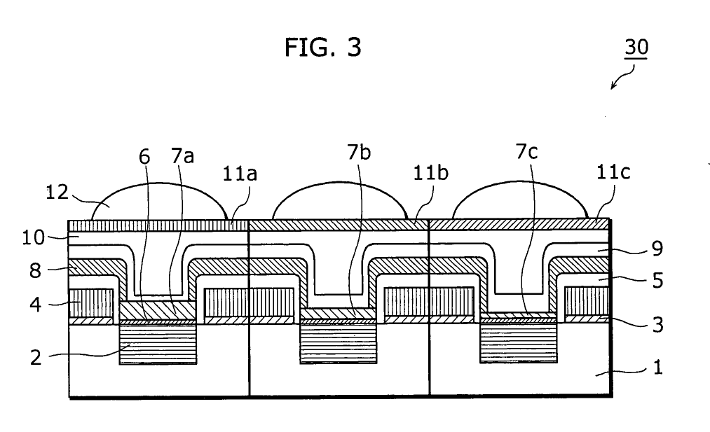

FIG. 3 is a cross-section diagram showing a structure of a solid-state image sensor according to the first embodiment of the present invention. Here, the diagram shows an example of using color filters as optical units which divide incident light into a plurality of color lights. The color filters respectively pass only incident light made of light components of red (R), green (G) and blue (B). The diagram only shows three light receiving units respectively for RGB which constitute the solid-state image sensor. In general, a solid-state image sensor is made up of the plurality of light receiving units shown in FIG. 3 being arranged in an array. Note that, whereas the light receiving units for RGB are arranged in a row, the arrangement varies in actual cases. For example, it may be a state where the light receiving units for RGB are respectively separated.

In the solid-state imaging apparatus 30 shown in FIG. 3, light receptors 2 that are photodiodes are formed in an upper part of a p-type silicon substrate 1. An insulating film 3 that is made of a silicon oxide film is formed in a region on the top of the p-type silicon substrate 1 except on the top of each of the light receptors 2. A transfer electrode 4 is formed on the insulating film 3, and the transfer electrode 4 is covered with an interlayer insulating film 5. Silicon oxide films 6 are formed covering the top surface of respective light receptors 2. Antireflection films 7a, 7b and 7c for RGB are respectively formed on top of the silicon oxide films 6. A shielding film 8 made from aluminum is formed on top of the interlayer insulating film 5 without covering the top of each light receptor 2. A passivation film 9 made from silicon oxide film material, a flat film 10, a color filter 11 and a microlens 12 are sequentially formed on the shielding film 8.

The solid-state image sensor 30 has a same structure as that of the conventional solid-state image sensor except that thicknesses of the antireflection films 7a, 7b and 7c are set to values which are different depending on the color of light entering each light receptor. Note that, whereas the antireflection films 7a, 7b and 7c are formed only on top of the respective light receptors 2, not only limited to this, it is no doubt that each of the antireflection films 7a, 7b, and 7c may be formed on or under the transfer electrode 4, or formed up to the top of the shielding film 8.

Here, in the mentioned solid-state image sensor 30, it is defined that a component of the antireflection films 7a, 7b and 7c is nitride silicon. However, not only limited to this, it may be a material having a refractive index between silicon and silicon oxide film (e.g. titanium oxide, niobium oxide, tantalum oxide, zirconium oxide, indium oxide, cerium oxide, hafnium oxide, molybdenum oxide, tin oxide, zinc oxide and zinc sulfide).

Next, an example about a manufacturing method of the solid-state image sensor in the present embodiment is explained.

First, each of the light receptors 2, which is a photodiode, is formed on the p-type silicon substrate 1 by ion implanting n-type impurities into the p-type silicon substrate 1, and grows the insulating film 3 that is made up of a silicon oxide film with the thickness of 50 nm by thermal oxidation. Next, a poly-silicon film with the thickness of 200 nm is grown by a Chemical Vapor Deposition (CVD) method, and the transfer electrodes 4 are formed by dry etching. After that, each of the transfer electrodes 4 is covered with the silicon oxide film by heat oxidation and the silicon oxide film is called as the interlayer insulating film 5. After reducing the rest of the silicon oxide films 6 on the respective light receptors 2 to 20 nm by wet etching, the antireflection films 7a, 7b and 7c that are respectively made up of a silicon nitride film with the thickness of 60 nm are grown on all faces of the substrate by the CVD method. After that, the silicon nitride film in the region other than the top of the respective light receptors 2 is removed by wet etching, and the thickness of the silicon nitride film on the G light receptor is reduced to 50 nm and the thickness of the silicon nitride film on the B light receptor is reduced to 40 nm.

Following that, the shielding film 8 with the thickness of 400 nm made from Aluminum is formed by a spattering method and an opening region is formed on each of the light receptors 2 by dry etching. Further, the whole substrate is covered with the passivation film 9 that is made of a silicon oxide film with the thickness of 200 nm by the CVD method. After that, using a known technology, the flat film 10, the color filter 11 and the microlens 12 are formed so that the solid-state image sensor 30 is obtained. Thus, thicknesses of the antireflection films 7a, 7b and 7c on the respective R light receptor, a G light receptor and a B light receptor are defined respectively to 60 nm, 50 nm and 40 nm.

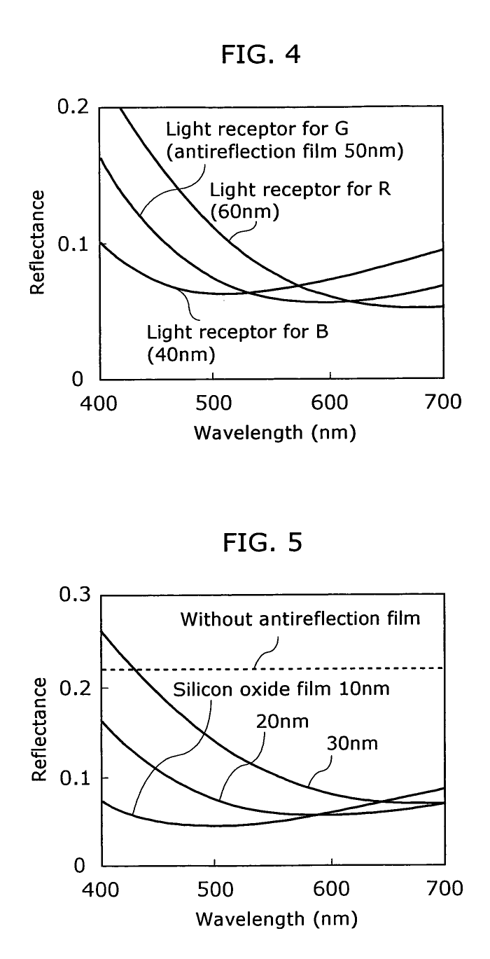

FIG. 4 shows a result of measuring a photoreflectance of light entered from the aperture of the shielding unit 8 in the solid-state image sensor 30.

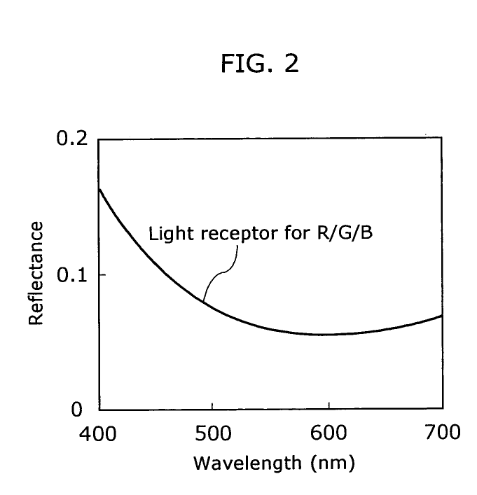

In comparison between FIG. 4 and FIG. 2, in the solid-state image sensor in the present embodiment, a photoreflectance in a wavelength range can be selectively reduced to the blue light entering the B light receptor and red light entering the R light receptor. Therefore, it is clear that the solid-state image sensor as a whole can seek for sure to reduce reflection of incident light.

Note that, the manufacturing method is a manufacturing method of forming the antireflection film made of a silicon nitride film with the thickness of 60 nm on each light receptor 2 using the CVD method, and of reducing the thicknesses of the silicon nitride films on the G light receptor and the B light receptor. However, same result is obtained by a manufacturing method of forming the antireflection film made of a silicon nitride film with the thickness of 40 nm on each light receptor using the CVD method, and of increasing the thicknesses of the silicon nitride films on the R light receptor and the G light receptor using the CVD method. Also, whereas the wet etching is used as the method of reducing the thickness of the antireflection film, a dry etching may be used. Additionally, whereas the CVD method is used as a forming method of the antireflection films 7a, 7b and 7c and as the method of increasing the thicknesses of the antireflection films, a spattering method or any other methods may be used.

Further, in the manufacturing method, thicknesses of the silicon nitride films on the R light receptor, G light receptor and B light receptor are respectively 60 nm, 50 nm and 40 nm. The same effect is obtained if the antireflection film over the light receptor which receives light of first color (e.g. blue light) is thinner the antireflection film over the light receptor which receives light of second color (e.g. blue light, red light) that has longer wavelength than that of the first color. It is more preferred to set a thickness of antireflection film for each color of light entering each light receptor so as to have a minimum photoreflectance in a wavelength range of the light. With this structure, the reflection of incident light can be more effectively controlled.

Also, it is described that the antireflection films 7a, 7b and 7c are formed only on the respective light receptors 2. However, not only limited to this, the same result can be obtained unless the structure above the light receptors 2 is same as the above mentioned structure even if each of the antireflection films 7a, 7b and 7c are formed on or under the transfer electrode 4 or up to the top of the shielding film 8.

As explained in the above, by the manufacturing method of the solid-state image sensor, each of the antireflection films 7a, 7b and 7c formed after the silicon oxide film 6 on the respective light receptor 2 is reduced to 20 nm by wet etching. However, each of the antireflection films 7a, 7b and 7c may be formed after the silicon oxide film 6 on the respective light receptor 2 is completely removed. Also, each of the remaining silicon oxide film 6 may be around 5 nm to 25 nm by adjusting time of the wet etching. In terms of picture quality such as so-called white scratches or dark currents, it is preferred that the silicon oxide film 6 is formed between the silicon substrate 1 and each of the antireflection films 7a, 7b and 7c and more preferred that the thickness of the silicon oxide film 6 is 25 nm or less.

FIG. 5 shows a result of measuring photoreflectance in each solid-state image sensor for RGB by fixing the antireflection film 7 to a silicon nitride film with the thickness of 50 nm and changing the thicknesses of the silicon oxide films 6 to respectively 10, 20 and 30 nm. As shown in the diagram, the thicker the silicon oxide films 6, the smaller the effective refractive index of the silicon oxide films 6 and the antireflection films 7. In particular, antireflection effect against blue light is reduced.

As described in the above, according to the structure of the embodiment, the reflection of incident light entering each of the light receptors 2 can be effectively controlled for light in all wavelengths so that a solid-state image sensor with high sensibility and good quality of output picture can be obtained.

### Second Embodiment

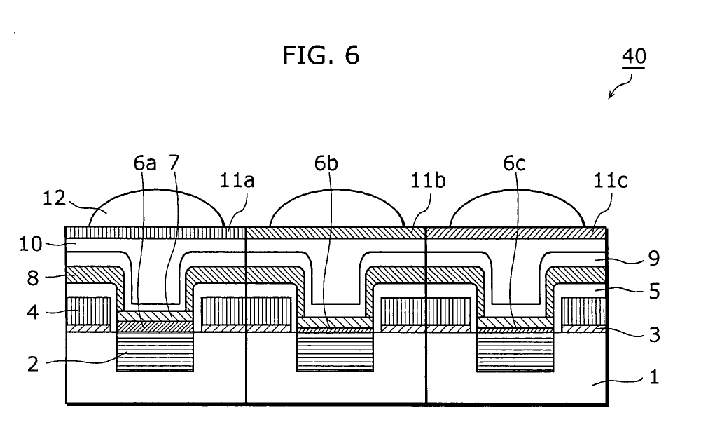

FIG. 6 is a cross-section diagram showing a structure of a solid-state image sensor according to second embodiment of the present invention. The structure of the solid-state image sensor 40 is same as in the case of the first embodiment shown in FIG. 3 except the following. That is, in the present embodiment, thickness of each antireflection film 7 is same for all of the R light receptor, the G light receptor and the B light receptor, and the thicknesses of the silicon oxide films 6a, 6b and 6c are set to values which differ depending on each color of light entering each light receptor 2. In other words, the solid-state image sensor 40 has a same structure as that of the conventional solid-state image sensor except that the thicknesses of the silicon oxide films 6a, 6b and 6c are set to values which differ depending on each color of light entering each light receptor 2. Here, the RBG light receptors are arranged in a row in the diagram. However, the arrangements vary in actual cases. For example, the RGB light receptors may surely be separated respectively.

Next, an example about a manufacturing method of a solid-state image sensor in the present embodiment is explained.

The procedure from the process of forming the light receptors 2 by the ion implantation to the process of forming an interlayer insulating film 5 by covering the transfer electrodes 4 with the silicon oxide by thermal oxidation is same as the procedure explained in the first embodiment. Next, after reducing the remaining thickness of the silicon oxide films on the light receptors 2 to 20 nm by wet etching, the silicon oxide films on the G light receptor and the B light receptor are reduced to 10 nm further by wet etching. After that, the antireflection film 7 composed of a silicon nitride film with the thickness of 50 nm is grown whole area of the substrate by the CVD method.

Following that, the silicon nitride film is removed except on the light receptors 2 by wet etching. Then, the solid-state image sensor 40 is obtained following the procedure which is same as in the first embodiment, from the process of forming the shielding film 8 by the spattering method to the process of forming the microlens 12. Thus, the thicknesses of the silicon oxide films on the R light receptor, the G light receptor and the B light receptor are defined respectively as 20 nm, 10 nm and 10 nm.

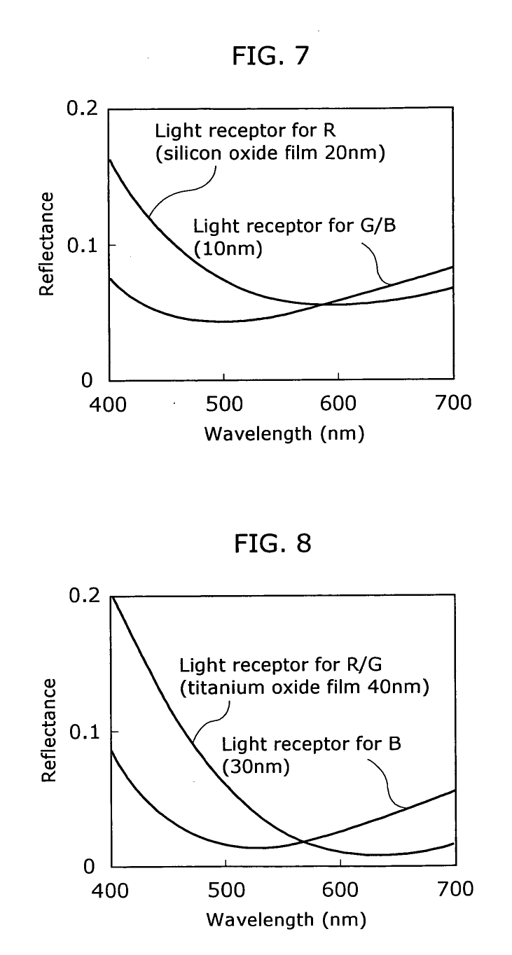

FIG. 7 shows a result of measuring photoreflectance of light entered from the aperture of the shielding film 8 in the solid-state image apparatus 40. In a comparison between FIG. 7 and FIG. 2, according to the solid-state image sensor in the present embodiment, the photoreflectance in a wavelength range can be selectively reduced for a green light entering the G light receptor and a blue light entering the B light receptor. Therefore, the solid-state image sensor as a whole can reduce for sure the reflection of incident light toward lights in all wavelength ranges.

Also, the measurement of dark currents and white scratch flaws shows a same result as in the case of the first embodiment. From this result, it can be verified that, even in the case where thickness of the antireflection film 7 is restricted, the reflection of light entering each light receptor 2 for each element of colors separated by the optical unit can be reduced because that flaws in picture quality such as white scratches are caused due to an internal stress of the antireflection film 7.

Also, according to the manufacturing method, the silicon oxide films 6a, 6b and 6c on the R light receptor, the G light receptor and the B light receptor are respectively defined as 20 nm, 10 nm and 10 nm. However, the same effect is obtained even from a structure in which the antireflection film 7 above the light receptor 2 which receives light of a first color (e.g. blue light) is thinner than the antireflection film 7 above the light receptors 2 which receives light of a second color having a longer wavelength than the first color (e.g. green light, red light).

It is more preferred to set the thicknesses of the silicon oxide films 6a, 6b and 6c so as to minimize the photoreflectance in a wavelength range of the light for each color entering each light receptor 2. According to the structure, the reflection of incident light can be controlled further effectively.

Note that, in the mentioned manufacturing method of the solid-state image sensor, the silicon oxide films on the respective light receptors 2 are reduced to 20 nm by wet etching, and the anti reflection films 7 are further formed respectively after reducing the silicon oxide films on the G light receptor and the B light receptor to 10 nm. However, the antireflection films 7 may be formed after completely removing the silicon oxide films on the G light receptor and the B light receptor.

Further, by adjusting time of wet etching, the remaining thicknesses of the silicon oxide films may be set around 5 nm to 25 nm. In terms of picture quality such as so-called white scratch flaws and dark currents, it is preferred that silicon oxide films are formed between the silicon substrate 1 and each antireflection film 7 and further preferred that the thicknesses of the silicon oxide films 6a, 6b and 6c are 5 nm or more.

According to the preferred examples, crystal flaws caused inside the silicon substrate influenced by the etching and the like performed in latter processes can be reduced so that the flaws in picture quality such as white scratches are unlikely to be occurred. However, if the silicon oxide films 6a, 6b and 6c are 5 nm or thinner, local leak currents generated due to the dispersion of thicknesses and dark current generated due to interface state increase. On the other hand, in terms of antireflection, it is preferred that the silicon oxide films 6a, 6b and 6c are thinner and that the thicknesses of the silicon oxide films 6a, 6b and 6c are 25 nm or thinner.

Further, in the manufacturing method of the solid-state image sensor, the process of setting thicknesses of the silicon oxide films 6a, 6b and 6c to values which vary for each color entering each light receptor 2 is the process of reducing the thickness of the silicon oxide film by the etching method. However, the manufacturing method may be the process of increasing the thickness of the silicon oxide film using the CVD method, the spattering method or the method including the both.

As described in the above, according to the structure of the present embodiment, even in the case where the thickness of the antireflection film 7 is restricted, the reflection of the incident light can be effectively controlled toward light in all wavelength ranges entering each light receptor 2 because that flaws in picture quality such as white scratches are caused due to internal stress of the antireflection film 7. Therefore, the solid-state image sensor with high sensibility and good picture quality of output picture can be obtained.

### Third Embodiment

The structure of a solid-state image sensor according to a third embodiment of the present invention is same as in the case of the first embodiment as shown in FIG. 3 except the following. In the present embodiment, titanium oxide accumulated by the spattering method is used as the antireflection films 7a, 7b and 7c. Also, in respect of thicknesses of the antireflection films 7a, 7b and 7c, it is same that the thicknesses are set to values which vary for each color of light entering each light receptor 2. However, structures of those thicknesses differ.

Next, an example about a manufacturing method of the solid-state image sensor in the present embodiment is explained.

The procedure from the process of forming the light receptors 2 by ion implantation and to the process of forming an interlayer insulating film 5 by covering the transfer electrodes 4 with silicon oxide films by thermal oxidation is same as the procedure described in the first embodiment. Next, after reducing the thicknesses of the silicon oxide films 6 on the light receptors 2 to 20 nm by the wet etching, the antireflection film made of a titanium oxide film with the thickness of 40 nm by the spattering method is grown on whole of the substrate. Following that, after removing the titanium oxide film except above the light receptors 2 by the wet etching, the thickness of the titanium oxide film on the B light receptor is further reduced to 30 nm by the wet etching. Then, the solid-state image sensor is formed through the same procedure as in the first embodiment from the process of forming the shielding film 8 by the spattering method to the process of forming the microlens 12. Thus, the thicknesses of the antireflection films 7a, 7b and 7c on the R light receptor, the G light receptor and the B light receptor are respectively set to 40 nm, 40 nm and 30 nm.

FIG. 8 shows a result of measuring the photoreflectance of light entered from the aperture of the shielding film 8 in the solid-state image sensor. In comparison between FIG. 8 and FIG. 2, according to the solid-state image sensor in the present embodiment, the photoreflectance of the light in a wavelength range is reduced for all of red light entering the R light receptor, green light entering the G light receptor, and blue light entering the B light receptor. As the result, it can be verified that the solid-state image sensor as a whole can seek for sure to reduce the photoreflectance of the incident light for light in all wavelength ranges.

Also, the measurement of dark current generated in the solid-state image sensor indicates 0.5 mV under the temperature condition at 60° C. When the dark current generated in the conventional solid-state image sensor having the antireflection film 7 made of a silicon nitride film is measured while making other conditions same, the result shows 1.0 mV. Therefore, the solid-state image sensor according to the present embodiment can reduce the amount of generated dark currents to the half.

Further, on an output screen of an image sensor using the conventional solid-state image sensor having the antireflection film 7 composed of a silicon nitride film, flaws of white scratches are found in 10 pixels out of a million pixels. On the other hand, in an image sensor using the solid-state image sensor in the present embodiment, a flaw of white scratches is not found.

Consequently, it is clear that the internal stress is reduced compared to nitride silicon which is conventionally used and the internal stress at a step and the like generated in a film is also reduced, so that flaws in picture quality such as white scratches can be reduced. Also, the hydrogen permeability is high so that necessary hydrogen can be sufficiently supplied to the substrate for reducing dark currents.

Conventionally, in the case where the silicon nitride film is used as the antireflactance film 7, the shape is restricted for securing hydrogen permeability. However, the present invention does not require such restriction. Therefore, the shape of the antireflection film 7 can be set variously so that further high sensibility and simplification of the manufacturing process can be sought by designing the shape.

Here, in the manufacturing method of the mentioned solid-state image sensor, a spattering method is used for a method of forming the antireflection film. However, a CVD method or other methods may be used. Further, a process of setting the thicknesses of antireflection films to values which vary for each color entering each light receptor is a process of reducing the thicknesses of the antireflection films by the etching method. However, the process may be a process of increasing the thicknesses of the antireflection films by the CVD method, the spattering method or a manufacturing method including the both.

Note that, whereas, in the solid-state image sensor, the component of the antireflection films 7a, 7b and 7c is titanium oxide, not limited to this, it may be a material with a refractive index between silicon and silicon oxide film (e.g. niobium oxide, tantalum oxide, zirconium oxide, indium oxide, cerium oxide, hafnium oxide, molybdenum oxide, tin oxide, zinc sulfide).

Furthermore, a method of separating incident light into colors is not only limited to use the red, green and blue color filters. It may be a method of separating by using complementary color filters of cyan, magenta, yellow and green, or by using prism such as three-plate type CCD.

As described in the above, according to the structure in the present invention, the reflection of incident light can be controlled effectively to the light in all wavelength ranges entering each light receptor 2 so that a solid-state image sensor with high sensibility and good picture quality of output picture can be obtained even in the case where the thickness of the silicon oxide film on the antireflection film and the light receptor is restricted because flaws on the picture quality such as white scratches occur due to internal stress of the anti reflection film.

Note that the solid-state image sensor can be either the CCD type or the MOS type.

Although the present invention has been fully described by way of examples with reference to the accompanying drawings, it is to be noted that various changes and modifications will be apparent to those skilled in the art. Therefore, unless otherwise, such changes and modifications depart from the scope of the present invention, they should be construed as being included therein.

1. A solid-state image sensor which captures an image, comprising:
optical units operable to separate incident light into a plurality of color lights, each of said optical units separating the incident light into one of the color lights;
light receptors respectively corresponding to the color lights, each of said light receptors being formed in a semiconductor substrate, and each of said light receptors converting one of the color lights separated by said optical unit into a charge; and
antireflection films, each formed above respective light receptor and reducing light reflection on a surface of said light receptor, said antireflection films including at least two types of films, and a thickness of a first type of said films being different from a thickness of a second type of said films.

2. The solid-state image sensor according to claim 1,
wherein said antireflection films includes first antireflection films for a first-color light and second antireflection films for a second-color light, said first antireflection films being thinner than said second antireflection films, and the second-color light having a longer wavelength than the first-color light.

3. The solid-state image sensor according to claim 2,
wherein a refractive index value of each of said antireflection films is between a refractive index value of the semiconductor substrate and a refractive index value of a film above each of said antireflection films.

4. The solid-state image sensor according to claim 2,
wherein each of said antireflection films includes at least one compound selected from the group consisting of titanium oxide, niobium oxide, tantalum oxide, zirconium oxide, indium oxide, cerium oxide, hafnium oxide, molybdenum oxide, tin oxide, zinc oxide and zinc sulfide.

5. The solid-state image sensor according to claim 1,
wherein a thickness of each of said antireflection films is set so as to have a minimum reflectance in a wavelength range of one of the color lights respectively entering said light receptors.

6. The solid-state image sensor according to claim 5,
wherein a refractive index value of each of said antireflection films is between a refractive index value of the semiconductor substrate and a refractive index value of a film above each of said antireflection films

7. The solid-state image sensor according to claim 5,
wherein each of said antireflection films includes at least one compound selected from the group consisting of titanium oxide, niobium oxide, tantalum oxide, zirconium oxide, indium oxide, cerium oxide, hafnium oxide, molybdenum oxide, tin oxide, zinc oxide and zinc sulfide.

8. The solid-state image sensor according to claim 1,
wherein said optical units include color filters for red, green and blue.

9. A solid-state image sensor which captures an image, comprising:
optical units operable to separate incident light into a plurality of color lights, each of said optical units separating the incident light into one of the color lights;
light receptors respectively corresponding to the color lights, each of said light receptors being formed in a semiconductor substrate, and each of said receptors converting one of the color lights separated by said optical units into a charge;
silicon oxide films, each formed above respective light receptor, said silicon oxide films including at least two types of films, and a thickness of a first type of said films being different from a thickness of a second type of said films; and
antireflection films, each formed above respective silicon oxide film, and reducing reflection on a surface of said light receptor.

10. The solid-state image sensor according to claim 9,
wherein said silicon oxide films includes first silicon oxide films for a first-color light and second silicon oxide films for a second-color light, said first silicon oxide films being thinner than said second silicon oxide films, and the second-color light having a longer wavelength than the first-color light.

11. The solid-state image sensor according to claim 10,
wherein a thickness of each of said silicon oxide films is from 5 nm to 25 nm inclusive.

12. The solid-state image sensor according to claim 10,
wherein a refractive index value of each of said antireflection films is between a refractive index value of the semiconductor substrate and a refractive index value of a film above each of said antireflection films

13. The solid-state image sensor according to claim 10,
wherein each of said antireflection films includes at least one compound selected from the group consisting of titanium oxide, niobium oxide, tantalum oxide, zirconium oxide, indium oxide, cerium oxide, hafnium oxide, molybdenum oxide, tin oxide, zinc oxide and zinc sulfide.

14. The solid-state image sensor according to claim 9,
wherein a thickness of each of said antireflection films is set so as to have a minimum reflectance in a wavelength range of one of the color lights respectively entering said light receptors.

15. The solid-state image sensor according to claim 14,
wherein a thickness of each of said silicon oxide films is from 5 nm to 25 nm inclusive

16. The solid-state image sensor according to claim 14,
wherein a refractive index value of each of said antireflection films is between a refractive index value of the semiconductor substrate and a refractive index value of a film above each of said antireflection films

17. The solid-state image sensor according to claim 14,
wherein each of said antireflection films includes at least one compound selected from the group consisting of titanium oxide, niobium oxide, tantalum oxide, zirconium oxide, indium oxide, cerium oxide, hafnium oxide, molybdenum oxide, tin oxide, zinc oxide and zinc sulfide.

18. The solid-state image sensor according to claim 9,
wherein said optical units include color filters for red, green and blue.

19. A solid-state image sensor which captures an image, comprising:
light receptors, each formed in a semiconductor substrate and converting incident light into a charge; and
antireflection films, each including at least one compound selected from the group consisting of titanium oxide, niobium oxide, tantalum oxide, zirconium oxide, indium oxide, cerium oxide, hafnium oxide, molybdenum oxide, tin oxide, zinc oxide, and zinc sulfide, the antireflection films being formed respectively above the light receptors.

20. A manufacturing method of a solid-state image sensor, comprising:
forming light receptors in a semiconductor substrate, each of the light receptors performing photoelectric conversion;
forming antireflection films above the respective light receiving receptors, each of the antireflection films having a thickness selected out of at least two types of thicknesses; and
forming optical units separating incident light into a plurality of color lights above the respective antireflection films, each of the optical units leading one of the separated color light into the respective light receptor.

21. The manufacturing method of the solid-state image sensor according to claim 20,
wherein in said forming of the antireflection films including first antireflection films for a first-color light and second antireflection films for a second-color light, the first antireflection films are formed so as to be thinner than the second antireflection films, the second color light having a longer wavelength than the first color light.

22. The manufacturing method of the solid-state image sensor according to claim 20,
wherein in said forming of the antireflection films, a thickness of each of the antireflection films is set so as to have a minimum reflectance in a wavelength range of one of the color light of the incident light.

23. The manufacturing method of the solid-state image sensor according to claim 20,
wherein said forming of the antireflection films includes at least one of reducing the thickness of the antireflection film by an etching method, and of increasing the thickness of the antireflection film by a Chemical-Vapor Deposition method or a spattering method.

24. A manufacturing method of a solid-state image sensor, comprising:
forming light receptors in a semiconductor substrate, each of the light receptors performing light conversion;
forming silicon oxide films above the respective light receptors, each of the silicon oxide films having a thickness selected out of at least two types of thicknesses; and
forming optical units separating incident light into a plurality of color lights above the respective antireflection films, each of the optical units leading one of the separated color light into the respective light receptor.

25. The manufacturing method of the solid-state image sensor, according to claim 24,
wherein in said forming of the silicon oxide films including first silicon oxide films for a first-color light and a second silicon oxide films for a second-color light, the first silicon oxide films are formed so as to be thinner than the second silicon oxide films, the second-color light having a longer wavelength than the first-color light.

26. The manufacturing method of the solid-state image sensor, according to claim 24,
wherein in said forming of the silicon oxide films, a thickness of each of the silicon oxide films is set so as to have a minimum reflectance in a wavelength range of one of the color light of the incident light.

27. The manufacturing method of the solid-state image sensor according to claim 24,
wherein said forming of the silicon oxides films includes at least one of reducing each silicon oxide film by an etching and of increasing the thickness of each silicon oxide film by one of a Chemical-Vapor Deposition method and a spattering method.
